(19) United States
(12) Patent Application Publication
(10) Pub. No.: US 2026/0371348 A1
(43) Pub. Date: Nov. 19, 2026

(54) MULTIPLEXING OF PUCCH REPETITIONS, APPARATUS, COMPUTER-READABLE STORAGE MEDIUM, AND SOFTWARE PRODUCT

(71) Applicant: ZTE CORPORATION, Shenzhen, Guangdong (CN)

(72) Inventors: Wei GOU, Shenzhen (CN); Xianghui HAN, Shenzhen (CN); Junfeng ZHANG, Shenzhen (CN); Jing SHI, Shenzhen (CN); Shuaihua KOU, Shenzhen (CN)

(21) Appl. No.: 19/135,523

(22) PCT Filed: Jan. 9, 2023
(86) PCT No.: PCT/CN2023/071318

§ 371 Date: Jun. 4, 2025

(51) Int. Cl. H04W 72/21; H04L 1/08; H04W 72/566

(52) U.S. Cl. CPC H04W 72/21; H04L 1/08; H04W 72/566

(57) ABSTRACT

A wireless communication method is provided. The method includes: determining a plurality of PUCCHs overlap in time domain and at least one of the plurality of PUCCHs has a repetition factor greater than 1; multiplexing multiple pieces of uplink control information (UCI) of the plurality of PUCCHs to obtain a resulted PUCCH if a predefined condition being satisfied; and transmitting the resulted PUCCH to a base station. Apparatus and computer-readable medium configured to implement the disclosed methods are also provided.

### CROSS REFERENCE

This disclosure is a national stage filing under 35 U.S.C. § 371 of international application number PCT/CN2023/071318, filed Jan. 9, 2023, the entire contents of which are incorporated herein by reference.

### TECHNICAL FIELD

This disclosure is generally related to PUCCH repetitions, and more particularly to the multiplexing of PUCCH repetitions.

### BACKGROUND

Wireless communication technologies are pivotal components of the increasingly interconnecting global communication networks. Wireless communications rely on accurately allocated time and frequency resources for transmitting and receiving wireless signals. PUCCH (Physical Uplink Control Channel) carries uplink control information from a user equipment (UE) to a base station (BS). The PUCCH repetition technique provides a better uplink coverage performance for UEs at the cell edge. However, allocation the resources for the PUCCH repetition scheme may have influence to the overall performance of uplink (UL) and downlink (DL) transmission.

### SUMMARY

This summary is a brief description of certain aspects of this disclosure. It is not intended to limit the scope of this disclosure.

An embodiment of this disclosure provides a wireless communication method, including:
determining a plurality of PUCCHs overlap in time domain and at least one of the plurality of PUCCHs has a repetition factor greater than 1;
multiplexing multiple pieces of uplink control information (UCI) of the plurality of PUCCHs to obtain a resulted PUCCH if a predefined condition being satisfied; and
transmitting the resulted PUCCH to a base station.

Another embodiment of this disclosure provides a wireless communication method, including:
determining a plurality of PUCCHs overlap in time domain and at least one of the plurality of PUCCHs has a repetition factor greater than 1; and
receiving resulted PUCCH that is resulted from multiplexing multiple pieces of uplink control information (UCI) of the plurality of PUCCHs to obtain a resulted PUCCH if a predefined condition being satisfied.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when performed by a processor, cause to perform any method or step or their combination in this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system, which can implement the methods and/or steps in this disclosure;

FIG. 2A shows a time slot diagram with multiple PUCCHs before multiplexing;

FIG. 2B shows a time slot diagram with multiple PUCCHs after multiplexing of FIG. 2A;

FIG. 3A shows a time slot diagram with multiple PUCCHs before multiplexing;

FIG. 3B shows a time slot diagram with multiple PUCCHs after multiplexing of FIG. 3A;

FIG. 4A shows a time slot diagram with multiple PUCCHs before multiplexing;

FIG. 4B shows a time slot diagram with multiple PUCCHs after multiplexing of FIG. 4A;

FIG. 5A shows a time slot diagram with multiple PUCCHs before multiplexing;

FIG. 5B shows a time slot diagram with multiple PUCCHs after multiplexing of FIG. 5A;

FIG. 6A shows a time slot diagram with multiple PUCCHs before multiplexing; and

FIG. 6B shows a time slot diagram with multiple PUCCHs after multiplexing of FIG. 6A.

### DETAILED DESCRIPTION

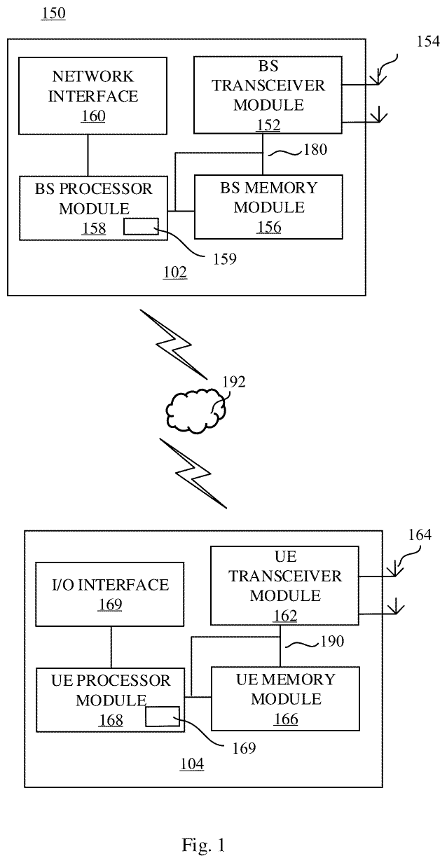

FIG. 1 illustrates a block diagram of an exemplary wireless communication system 150, in accordance with some embodiments of this disclosure. The system 150 may perform the various methods/steps disclosed in this disclosure. The system 150 may include components and elements configured to support operating features that need not be described in detail herein.

The system 150 may include a base station (BS) 102 and a user equipment (UE) 104. The BS 102 includes a BS transceiver or transceiver module 152, a BS antenna system 154, a BS memory or memory module 156, a BS processor or processor module 158, and a network interface 160. The components of BS 102 may be electrically coupled and in communication with one another as necessary via a data communication bus 180. Likewise, the UE 104 includes a UE transceiver or transceiver module 162, a UE antenna system 164, a UE memory or memory module 166, a UE processor or processor module 168, and an I/O interface 169. The components of the UE 104 may be electrically coupled and in communication with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from a transmitting antenna of the UE 104 (referred to singular form for convenience, but can include multiple antennae) to a receiving antenna of the BS 102 (referred to singular form for convenience, but can include multiple antennae) is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. There may be close synchronization timing with only a minimal guard time between changes in duplex direction. The UE transceiver 162 communicates through the UE antenna 164 with the BS 102 via the wireless communication channel 192. The BS transceiver 152 communicates through the BS antenna 154 of a BS (e.g., the first BS 102) with the other BS (e.g., the second BS 102-2) via a wireless communication channel 192. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long-Term Evolution (LTE) and 5G standards (e.g., NR), and the like. It is understood, however, that the invention is not necessarily limited in application to a particular standard and associated protocols. Rather, the UE transceiver 162 and the BS transceiver 152 may be configured to support alternative, or additional, wireless data communication protocols, including future standards or variations thereof.

The processor modules 158 and 168 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 158 and 168, respectively, or in any practical combination thereof. The memory modules 156 and 166 may be realized as RAM memory, flash memory, EEPROM memory, registers, ROM memory, EPROM memory, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be performed by processor modules 158 and 168, respectively. The memory modules 156 and 166 may also each include non-volatile memory for storing instructions to be performed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)) or one or more core network for mobile communications. The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

PUCCH (Physical Uplink Control Channel) carries a set of information “UCI (Uplink Control Information).” Depending on what kind of information the UCI in PUCCH carries, PUCCH is classified into various formats. The content of the UCI may include, for example, channel quality information, acknowledgements, and scheduling requests. PUCCH repetitions transmission may improve PUCCH reliability and coverage. The repetition technique allows UE to transmit the same or similar PUCCH repetitively to ensure a BS receives accurate information to management the signal transmission between the BS and the UE. PUCCH repetition factors may control the times a PUCCH transmitted repetitively for a cycle. A PUCCH repetition factor N can be generally configured or indicated as 2, 4 or 8. The repetitions can be a pre-determined factor between the BS or UE, and it can also be a factor indicated by an RRC (Radio Resource Control) signaling. Therefore, after a PUCCH with repetitions is triggered, the PUCCH is repeatedly transmitted 2 (N=2), 4 (N=4) or 8 (N=8) times according to the configured or indicated repetition factor.

For a PUCCH with repetition factor N (N>1), the time slot or subslot where the first PUCCH repetition is transmitted may be configured or indicated by UE who transmits the PUCCH. In a Time Division Duplex (TDD) cell, the slots of the remaining PUCCH repetitions can be determined based on at least one or more of the following rules: If a UL symbol or flexible symbol can be provided in a slot; the UL symbol or flexible symbol is of the same type (for example, with the same symbol index in the slot) with the starting symbol configured for the PUCCH; and/or in the slot, starting from the UL symbol or flexible symbol, consecutive following UL symbols or flexible symbols can be provided, and the total number of UL symbols or flexible symbols is greater than or equal to the number of symbols configured for the PUCCH (such that there is a sufficient space/symbols to fit the PUCCH). Then, a slot meeting the requirements can be determined for the remaining PUCCH repetitions.

According to embodiments of this disclosure, when a PUCCH with repetitions overlaps in the time domain with other PUCCH(s) (with or without repetition) in time domain, UCI multiplexing between these PUCCHs with the same or different types of UCIs between the overlapping PUCCHs is proposed and discussed with various implementations.

### Embodiment 1

The UCI multiplexing can be implanted, for example, when in a time slot, more than one PUCCHs are scheduled or configured to start from the (same) slot. The multiplexing can further condition on these PUCCHs having overlap(s) in the time domain in the slot. The multiplexing can further condition on these PUCCHs having the same repetition factor N (where N is an integer greater than 1). In one implementation, when all the above conditions are met, UCI multiplexing can be performed for the UCIs in these PUCCHs from or in the same slot. A resulted PUCCH of the multiplexing can be obtained and transmitted N times repeatedly. The repetition factor N here can be, but not necessarily, equal to the maximum repetition factor among the repetition factors of these PUCCHs participating in the UCI multiplexing.

For example, a PUCCH with a repetition factor N1 (N1>1) is configured or scheduled to start from slot n, and one or more PUCCHs with repetition factor N2 (N2>1) are also configured or scheduled to start from the slot n, wherein N1=N2. These PUCCHs overlap in the time domain. The UCI multiplexing can be performed for UCIs in these PUCCHs, and then a multiplexing resulted PUCCH is obtained.

### UCI Types on the Multiplexed PUCCHs

According to one implementation, the type of UCI may be a factor in determining whether to perform UCI or PUCCH multiplexing. According to one implementation, the PUCCH multiplexing is conditioned on the UCI types in PUCCHs participating in UCI multiplexing are the same. For example, types of UCI can be defined by the content(s) it carries. For example, PUCCHs carry HARQ-ACK (Acknowledgement), CSI (Channel Status Information), or SR (Scheduling Request) can be defined as different types of PUCCH.

Alternatively or additionally, the types of UCI in PUCCHs participating in UCI multiplexing may be different (or are all different from each other). For example, the PUCCH multiplexing can be performed between an HARQ-ACK PUCCH and a SR PUCCH, between an HARQ-ACK PUCCH and a CSI PUCCH, between an HARQ-ACK PUCCH, an SR PUCCH and a CSI PUCCH, or between an SR PUCCH and CSI PUCCH.

Alternatively or additionally, the PUCCHs participating in the multiplexing include UCIs of the same types (e.g., a first type) and further include UCI of a different type (e.g., a second type). In this way, PUCCHs of the same type of UCI are multiplexed as a group first, and then one or more interim resulted PUCCHs are obtained. Two or more interim resulted PUCCHs can then be multiplexed with each other to obtain the final resulted PUCCH. Alternatively or additionally, one or more interim resulted PUCCHs can be multiplexed with an original PUCCH that have not been multiplexed, due to its different UCI type, to generated the final resulted PUCCH.

### The Repetition Factor of Resulted PUCCH(s)

According to this implementation, the resulted PUCCH can be used for PUCCH repetitions, meaning that the result PUCCH may be transmitted a plurality of times as PUCCH repetitions.

Exemplarily, the repetition factor of the resulted PUCCH can be equal to the greatest repetition factor among the repetition factors of the PUCCHs that were participating in the UCI multiplexing. For example, if one PUCCH (with N=2) and the other PUCCH (with N=4) are participating in the multiplexing, according to this example, the resulted PUCCH would have a repetition factor of N=4, meaning that the resulted PUCCH would be transmitted four times. If the PUCCHs participating in the UCI multiplexing all have the same repetition factor, the repetition factor of the resulted PUCCH is equal to the repetition factor of the same repetition factor.

According to one implementation, the resulted PUCCH may be one of the PUCCHs participating in UCI multiplexing. Alternatively or additionally, the resulted PUCCH can be different from the PUCCHs participating in the UCI multiplexing.

Alternatively or additionally, the repetition factor of the resulted PUCCH can be the repetition factor specifically configured for the PUCCH resource corresponding to the resulted PUCCH. For example, each PUCCH resource in a PUCCH resource set can be configured with a repetition factor. If UCI multiplexing is performed, one of the PUCCH resources among the PUCCH resource set can be selected from the PUCCH resource set as the resulted PUCCH. The selection can be based on a sum of a size of the multiplexed UCIs. Therefore, the repetition factor of the resulted PUCCH is equal to the repetition factor configured for the (determined) PUCCH. In this way, the multiplexing result PUCCH may not have a repetition factor if the PUCCH resource selected for the multiplexing result PUCCH is not configured with a repetition factor.

### Time Slots of the PUCCH Repetitions

The time slot used to transmit the first repetition of the resulted PUCCH can be a slot determined by the UE. The slot can be the first time slot originally scheduled for the PUCCH participating into the multiplexing. The time slot for the remaining PUCCH for the repetitions of the resulted PUCCH can be determined based on the following rules:

A UL symbol or flexible symbol can be provided in a time slot, and the UL symbol or flexible symbol is the same as the starting symbol configured for the resulted PUCCH (for example, with the same symbol index). In the time slot, starting from the UL symbol or flexible symbol, consecutive UL symbols or flexible symbols can be provided, and the number of the consecutive UL symbols or flexible symbols is greater than or equal to the number of symbols configured for the resulted PUCCH. According to the implantation, the time slot meet the above conditions can be determined to transmit the remaining repetitions of the resulted PUCCH.

In some cases, since the PUCCH format and/or symbols location of the resulted PUCCH may be different from that of the PUCCHs originally participating in the UCI multiplexing, the slots for the remaining repetitions determined according to the PUCCHs participating in UCI multiplexing are, therefore, disregarded. The slots for the remaining repetitions may be determined using the start symbol and the number of symbols of the resulted PUCCH.

### UCI Multiplexing in the Slot

In some examples, the UCIs may be divided into two or more types: UCI of a high physical layer priority or UCI of a low physical layer priority. The UCI multiplexing can be first performed for PUCCHs of the UCIs with the same physical layer priority to obtain resulted interim PUCCHs. Then, UCI multiplexing can be performed between the resulted interim PUCCHs of the UCIs with different physical layer priority (including the resulted PUCCHs outputted in the previous step). For example, the UCIs of the high layer priority can be multiplexed with each other to obtain a first interim resulted PUCCH, and the UCIs of the low high layer priority can be multiplexed with each other to obtain a second interim resulted PUCCH. Then, the first interim resulted PUCCH can be multiplexed with the second interim resulted PUCCH to obtain the final resulted PUCCH for PUCCH repetitions. If there is only one UCI of either type, the first step to multiplex the UCI can be skipped. The interim resulted PUCCH of the other type can be further multiplex with the only one UCI of a different type. Below provides some examples for various circumstance.

### Case 1: UCIs in the Participating PUCCHs Only Have the Same Physical Layer Priority

In this case, the PUCCHs participating in the UCI multiplexing have the same repetition factor and overlap in the time domain. The UCIs in the PUCCHs have the same physical layer priority (e.g., either high or low priority), then the UCI bits in the PUCCHs can be concatenated to obtain an interim bit sequence A. Then the bit sequence A can be encoded and modulated to obtain the data (the multiplexed UCI) transmitted in the resulted PUCCH. Optionally and additionally, the encoding and modulating can involve CRC (Cyclic redundancy) check encoding and modulating to allow the receiver to perform CRC check.

Alternatively or additionally, if the bit sequence A is of 1~2 bits, the bit sequence A can be directly modulated (without further encoding) to the agreed sequence according to the format of the resulted PUCCH (for example, PUCCH format 1), so the sequence modulated from the bit sequence A is the data to be transmitted in the resulted PUCCH.

Alternatively or additionally, if the bit sequence A is 1~2 bits, a sequence can be obtained by looking up a predefined table according to the value of the bit sequence A and according to the format of the resulted PUCCH (for example, PUCCH format 0), so the obtained sequence based on the looked up value from the table is the data to be transmitted in the resulted PUCCH. In both cases, the CRC check modulation can be skipped.

In any case above or in this disclosure, a CRC check modulation or encoding can be performed if the sequence A is larger than 2 bits.

### Case 2: UCIs in Two PUCCHs Have Different Physical Layer Priorities in One Slot

If the UCIs in the PUCCHs participating in the UCI multiplexing have different physical layer priorities (e.g., high and low priorities), then the UCIs bits with different physical layer priorities can be encoded and modulated respectively to obtain the transmitted data in the resulted PUCCH. The modulation and encoding can include CRC check encoding and modulation.

For example, if the UCIs in PUCCH1 with repetition factor N1 are of a high physical layer priority, and the UCIs in PUCCH2 with repetition factor N1 are of a low physical layer priority, then the UCIs in PUCCH1 can be encoded and modulated (optionally including CRC check encoding and modulation) to obtain transmitted data 1. The UCIs in PUCCH2 can be encoded and modulated (optionally including CRC check encoding and modulation) to obtain the transmitted data 2. Data 1 and data 2 can be mapped to a same resulted PUCCH in the agreed order to form the resulted PUCCH with the resulted UCI.

Optionally, if the bit number of the UCI is greater than 2 bits, the CRC check encoding or modulation can be added.

### Case 3: UCIs in the PUCCHs Have the Same and Different Physical Layer Priorities in One Slot

In this case, the PUCCHs participating in UCI multiplexing have the same repetition factor and overlap in the time domain. The PUCCHs have UCIs of different physical layer priorities, but some UCIs' priority may be identical to other, but not all, UCIs of the PUCCHs participating in the multiplexing. As an example, the UCIs in some PUCCHs of these PUCCHs have a high physical layer priority, and the UCIs in the remaining PUCCHs have a low physical layer priority, UCI multiplexing can be performed as follows:

There may be one or more PUCCHs having UCIs of the high physical layer priority. There may also be one or more PUCCHs having UCIs of the low physical layer priority. Therefore, if the UCIs of one physical layer priority include multiple PUCCHs, UCI multiplexing can be performed based on the multiple PUCCHs of the respectively same physical layer priority to obtain interim resulted PUCCHs. Alternatively, if the UCIs of one physical layer priority have only one PUCCH, this step can be skipped. If this step is skipped, there would be no interim resulted PUCCH generated for this priority. The single original PUCCH can be multiplexed with an interim resulted PUCCH generated for another physical layer priority.

Specifically, UCI multiplexing is first performed among the PUCCHs of UCIs with the same high or low physical layer priority respectively (assuming there are multiple PUCCHs of the same high or low physical layer priority). One or more interim resulted PUCCHs can be obtained. If there is only one PUCCH having the UCI of the low or high physical layer priorities, then there would be only one interim resulted PUCCH.

Second, UCI multiplexing can be performed between the interim resulted PUCCHs or between one interim resulted PUCCH and the single original PUCCH of its own physical layer priority to obtain the final resulted UCI to be transmitted as the final resulted PUCCH. The final resulted PUCCH is transmitted from a slot n.

Exemplarily, the physical layer priority of the resulted PUCCH can be equal to the highest physical layer priority among the physical layer priority of UCIs participating in UCI multiplexing. For example, if both UCI of high priority and low priority were participating in the multiplexing, the physical layer priority of the resulted UCI of the result PUCCH can be the high physical priority.

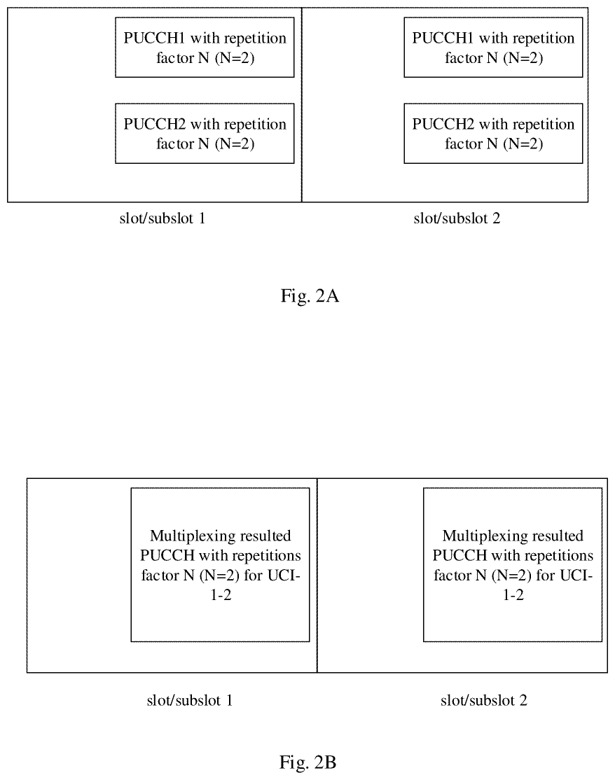

Referring to FIG. 2A as an example, PUCCH1 and PUCCH2 are scheduled and configured to start transmission from or in the first slot. They both have the same repetition factor N (N=2), and they overlap in the time domain and meet the multiplexing timeline in the first slot. As the above conditions are met, UCI multiplexing can be performed for UCI-1 in PUCCH1 and UCI-2 in PUCCH2 to obtain resulted UCI.

The UCI-1 bits in PUCCH1 and UCI-2 bits in PUCCH2 can be concatenated to obtain the bit sequence UCI-1-2. Assuming that the number of UCI-1-2 bits is greater than 2, the UCI-1-2 can be coded and modulated (including a CRC check mechanism) and then mapped to the resulted PUCCH for transmission.

FIG. 2B shows the multiplexing results for PUCCH1 and PUCCH2 in FIG. 1A. The repetition factor N of the multiplexing result PUCCH can be determined to be equal to the repetition factor of PUCCH1 or PUCCH 2 as they both have the same PUCCH repetition factor. The multiplexing result PUCCH can be transmitted from the first slot and repeated twice in total.

### Embodiment 2

In this embodiment, the pre-requisites for PUCCH multiplexing include: more than one PUCCHs are scheduled or configured to start from the (same) slot; these PUCCHs overlap in the time domain in the slot; and at least one of these PUCCHs has a repetition factor greater than 1. When the conditions are met, UCI multiplexing can be performed for the UCIs in these PUCCHs from or in the (same) slot. A resulted PUCCH is obtained and transmitted N times repeatedly, where N can be equal to the maximum repetition factor among the repetition factors of these PUCCHs participating in the UCI multiplexing.

### UCI Types on the Multiplexed PUCCHs

According to one implementation, the type of UCI may be a factor in determining whether to perform UCI or PUCCH multiplexing. According to one implementation, the PUCCH multiplexing is conditioned on the UCI types in PUCCHs participating in UCI multiplexing are the same. For example, types of UCI can be defined by the content(s) it carries. For example, PUCCHs carry HARQ-ACK (Acknowledgement), CSI (Channel Status Information), or SR (Scheduling Request).

Alternatively or additionally, the types of UCI in PUCCHs participating in UCI multiplexing may be different (or are all different from each other). For example, the PUCCH multiplexing can be performed between an HARQ-ACK PUCCH and an SR PUCCH, between an HARQ-ACK PUCCH and a CSI PUCCH, between an HARQ-ACK PUCCH, an SR PUCCH and a CSI PUCCH, or between an SR PUCCH and a CSI PUCCH.

Alternatively or additionally, the PUCCHs participating in the multiplexing include UCIs of the same types (e.g., a first type) and further include UCI of a different type (e.g., a second type). In this way, PUCCHs of the same type of UCI are multiplexed as a group first, and then one or more interim multiplexing resulted PUCCHs are obtained. Two or more interim multiplexing resulted PUCCHs can be multiplexed with each other to obtain the final resulted PUCCH. Alternatively or additionally, one or more interim resulted PUCCHs can be multiplexed with an original PUCCH that have not been multiplexed due to its different UCI type to generated the final resulted PUCCH.

### The Repetition Factor of Resulted PUCCH(s)

According to this disclosure, the resulted PUCCH can be used for PUCCH repetitions, meaning that the result PUCCH may be transmit a plurality of time as PUCCH repetitions.

Exemplarily, the repetition factor of the resulted PUCCH can be equal to the greatest repetition factor among the repetition factors of the PUCCHs that were participating in the UCI multiplexing. For example, if one PUCCH (with N=2) and the other PUCCH (with N=4) are participating in the multiplexing, according to this example, the resulted PUCCH would have a repetition factor of N=4, meaning that the resulted PUCCH would be transmitted four times. If the PUCCHs participating in the UCI multiplexing all have the same repetition factor, the repetition factor of the resulted PUCCH is equal to the repetition factor of the same repetition factor.

In some case, the UCIs in PUCCHs without a repetition factor are actually transmitted repeatedly. The number of repeated transmissions is equal to the repetition factor of the resulted PUCCH because the resulted PUCCH has a repetition factor greater than 1.

Alternatively or additionally, the repetition factor of the resulted PUCCH can be the repetition factor specifically configured for the PUCCH resource corresponding to the resulted PUCCH. For example, each PUCCH resource in a PUCCH resource set can be configured with a repetition factor. If UCI multiplexing is performed, one of the PUCCH resources among the PUCCH resource set is selected from the PUCCH resource set as the resulted PUCCH. The selection can be based on the sum of a size of the multiplexed UCIs. Therefore, the repetition factor of the multiplexing result PUCCH is equal to the repetition factor configured for the (determined) PUCCH. In this way, the multiplexing result PUCCH may not have a repetition factor if the PUCCH resource selected for the multiplexing result PUCCH is not configured with a repetition factor.

In some cases, the resulted PUCCH may be one of the PUCCHs participating in UCI multiplexing or a new PUCCH that is different from the PUCCHs participating in UCI multiplexing.

### Time Slots of the PUCCH Repetitions

The time slot used to transmit the first repetition of the resulted PUCCH can be a slot determined by the UE. The slot can be the first time slot originally scheduled for the PUCCH participating into the multiplexing. The time slot for the remaining PUCCH for the repetitions of the resulted PUCCH can be based on the following rules:

A UL symbol or flexible symbol can be provided in a time slot, and the UL symbol or flexible symbol is the same as the starting symbol configured for the resulted PUCCH (for example, with the same symbol index). In the time slot, starting from the UL symbol or flexible symbol, consecutive UL symbols or flexible symbols can be provided, and the number of consecutive UL symbols or flexible symbols is greater than or equal to the number of symbols configured for the resulted PUCCH. According to implantation, the time slot meet all, some, or at least one of the above conditions can be determined to transmit the remaining repetitions of the resulted PUCCH.

In some cases, since the PUCCH format and/or symbols location of the resulted PUCCH may be different from that of the PUCCHs originally participating in the UCI multiplexing, the slots for the remaining repetitions determined according to the PUCCHs participating in UCI multiplexing are, therefore, disregarded. The slots for the remaining repetitions may be determined using the start symbol and the number of symbols of the resulted PUCCH.

### UCI Multiplexing in the Slot

In some examples, the UCIs may be divided into two types: UCI of a high physical layer priority or UCI of a low physical layer priority. The UCI multiplexing can be first performed for PUCCHs of the UCIs with the same physical layer priority to obtain resulted interim PUCCHs. Then, UCI multiplexing can be performed between the resulted interim PUCCHs of the UCIs with different physical layer priority (including the resulted PUCCHs outputted in the previous step). For example, the UCIs of the high layer priority can be multiplexed with each other to obtain a first interim resulted PUCCH, and the UCIs of the low high layer priority can be multiplexed with each other to obtain a second interim resulted PUCCH. Then, the first interim resulted PUCCH can be multiplexed with the second interim resulted PUCCH to obtain the final resulted PUCCH for PUCCH repetitions. If there is only one UCI of either type, the first step to multiplex the UCI can be skipped. The interim resulted PUCCH or the other type can be further multiplex with the only one UCI of a different type. Below provides some examples for various circumstance.

### Case 1: UCIs in the PUCCHs Only Have the Same Physical Layer Priority in One Slot

In this case, for the PUCCHs participating in UCI multiplexing, a part of the PUCCHs have the same repetition factor and the other PUCCHs have different repetition factors. If the UCIs in the PUCCHs have the same physical layer priority (e.g., either high or low priority), then the UCI bits in the PUCCHs can be concatenated to obtain an interim bit sequence A, and then the bit sequence A can encoded and modulated to obtain the data (the multiplexed UCI) transmitted in the resulted PUCCH. Optionally and additionally, the encoding and modulating can involve CRC (Cyclic redundancy) check encoding and modulating to allow the receiver to perform CRC check.

Alternatively or additionally, if the bit sequence A is 1~2 bits, the bit sequence A can be directly modulated to the agreed sequence according to the format of the resulted PUCCH (for example, PUCCH format 1), so the sequence modulated from the bit sequence A is the data to be transmitted in the resulted PUCCH.

Alternatively or additionally, if the bit sequence A is 1 to 2 bits, a sequence can be obtained by looking up a predefined table according to the value of the bit sequence A and according to the format of the resulted PUCCH (for example, PUCCH format 0). The obtained sequence can be the data to be transmitted in the resulted PUCCH. In both cases, the CRC check does not need to be added. If the bit sequence A is greater than 2 bits, a CRC check can be added for the bit sequence A.

### Case 2: UCIs in Two PUCCHs Have Different Physical Layer Priorities in One Slot

If the UCIs in two PUCCHs have different physical layer priorities (e.g., high and low priorities), then the UCIs bits with different physical layer priorities can be coded and modulated respectively to obtain the transmitted data in the resulted PUCCH. The modulation and encoding can include CRC check encoding and modulation.

For example, if the UCIs in PUCCH1 with repetition factor N1 are of a high physical layer priority, and the UCIs in PUCCH2 with repetition factor N2 are of a low physical layer priority, then the UCIs in PUCCH1 can be encoded and modulated (optionally including CRC check encoding and modulation) to obtain transmitted data 1, and the UCIs in PUCCH2 is encoded and modulated (optionally including CRC check encoding and modulation) to obtain transmitted data 2. Data 1 and data 2 can then be mapped to the same resulted PUCCH in the agreed order to form the resulted PUCCH with the resulted UCI.

Optionally, if the bit number of the UCI is greater than 2 bits, the CRC check encoding or modulation can be to be added.

### Case 3: UCIs in the PUCCHs Have the Same and Different Physical Layer Priorities in One Slot

In this case, the UCIs in some PUCCHs of the PUCCHs participating in UCI multiplexing have a high physical layer priority, and the UCIs in the remaining PUCCHs have a low physical layer priority.

There may be one or more PUCCHs having UCIs of the high physical layer priority. Likewise, there may also be one or more PUCCHs having UCIs of the low physical layer priority. Therefore, if the UCIs of one physical layer priority include multiple PUCCHs, then UCI multiplexing can be performed for the multiple PUCCHs to obtain an interim resulted PUCCH. On the other hand, if the UCIs of one physical layer priority include only one PUCCH, this step can be skipped. If this step is skipped, there would be no interim resulted PUCCH generated for this priority. The single original PUCCH can be multiplexed with an interim resulted PUCCH generated for another physical layer priority.

Specifically, UCI multiplexing is first performed among the PUCCHs of UCIs with the same high or low physical layer priority respectively (assuming there are multiple PUCCHs of the same high or low physical layer priority). One or more interim resulted PUCCHs can be obtained. If there is only one PUCCH having the UCI of the low or high physical layer priorities, then there would be only one interim resulted PUCCH.

Second, UCI multiplexing can be performed between the interim resulted PUCCHs of UCIs with different physical layer priorities overlapped in time domain or between one interim resulted PUCCH and the single original PUCCH of its own physical layer priority to obtain the final resulted UCI to be transmitted as the final resulted PUCCH. The final resulted PUCCH may also be multiple non-overlapping PUCCHs in time domain.

Exemplarily, the physical layer priority of the resulted PUCCH can be equal to the highest physical layer priority among the physical layer priority of UCIs participating in UCI multiplexing. For example, if both UCI of high priority and low priority were participating in the multiplexing, the physical layer priority of the resulted UCI of the result PUCCH can be the high physical priority.

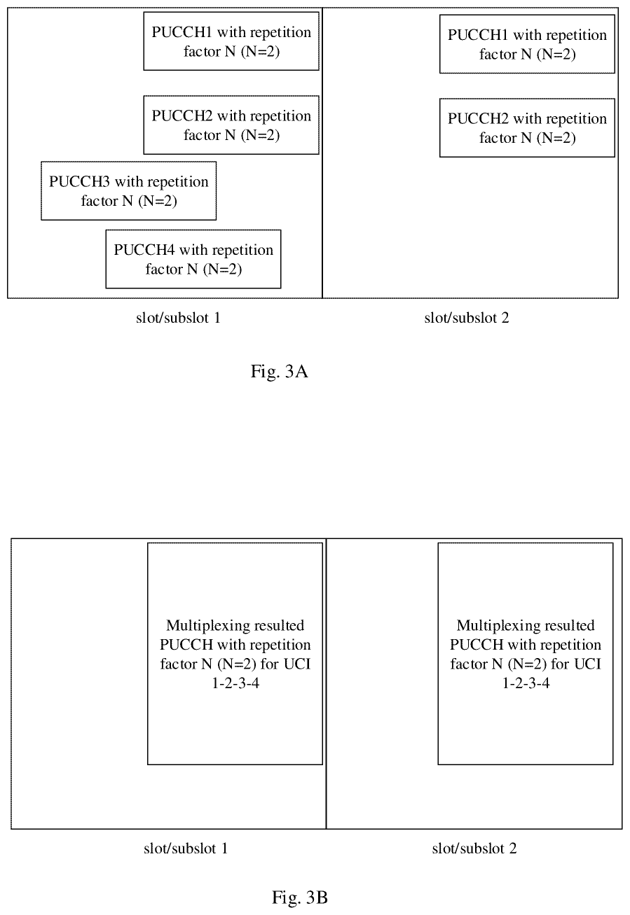

Referring to FIG. 3A, PUCCH1, PUCCH2, PUCCH3, and PUCCH4 are scheduled or configured to start transmission from the first slot. They overlap with each other in the time domain and meet the multiplexing timeline in the first slot. As the above conditions are met, UCI multiplexing can be performed for UCIs in these PUCCHs. Further, PUCCH1 and PUCCH2 have the same repetition factor 2. PUCCH3 and PUCCH4 have a repetition factor 1. Therefore, PUCCH3 and PUCCH4 do not have a repetition factor and are not transmitted repeatedly if there is no multiplexing. In this example, it is assumed that these PUCCHs have the same physical layer priority.

In performing the multiplexing, the UCIs bits corresponding to PUCCH1, PUCCH2, PUCCH3, and PUCCH4 are concatenated to obtain the bit sequence UCI-1-2-3-4 in the first slot (assuming that the number of bits of UCI-1-2-3-4 is greater than 2). UCI-1-2-3-4 can be added with a CRC check, and then be coded and modulated. Then, UCI-1-2-3-4 can be mapped to the resulted PUCCH for transmission.

FIG. 3B shows the resulted PUCCH for the overlapping PUCCHs in FIG. 3A in the first slot. The repetition factor N of the resulted PUCCH can be determined to be equal to the repetition factor of PUCCH1 or PUCCH2 because its repetition factor is the greatest one among the PUCCHs participating in UCI multiplexing. The resulted PUCCH can be transmitted from the first slot and repeated twice in total. The UCIs of PUCCH3 and PUCCH4 are transmitted one more time as compare to the pre-multiplexing UCIs.

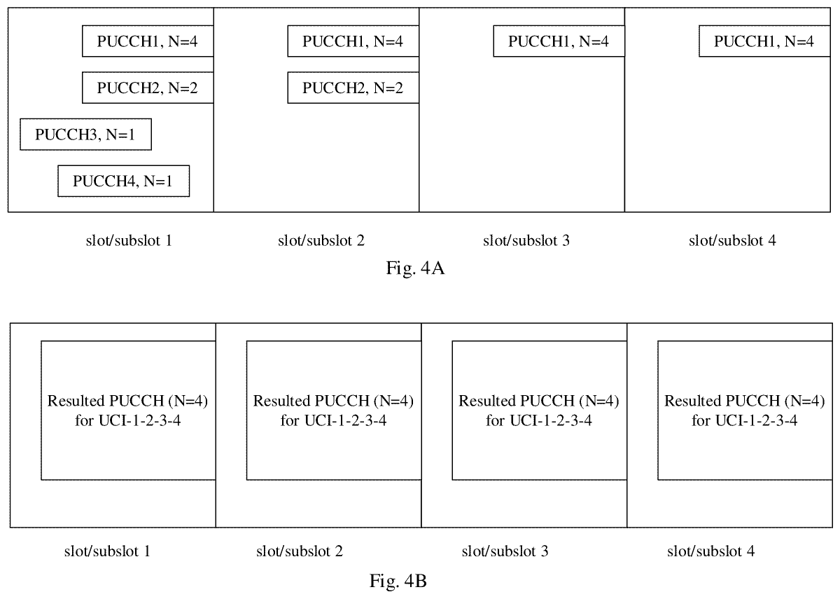

Referring to FIG. 4A as another example, PUCCH1, PUCCH2, PUCCH3, and PUCCH4 are scheduled or configured to start transmission from the first slot, and they overlap in the time domain and meet the multiplexing timeline in the first slot. As the above conditions are met, UCI multiplexing can be performed for UCIs in these PUCCHs. Further, PUCCH1 here have the same repetition factor 4. PUCCH2 have the same repetition factor 2. PUCCH3 and PUCCH4 have a repetition factor 1, meaning that, PUCCH3 and PUCCH4 do not have a repetition factor and are not transmitted repeatedly. Here, it is assumed that these PUCCHs have the same physical layer priority. The details are as follows:

To perform the multiplexing, the UCIs bits corresponding to PUCCH1, PUCCH2, PUCCH3, and PUCCH4 can be concatenated to obtain the bit sequence UCI-1-2-3-4 in the first slot (assuming that the number of bits of UCI-1-2-3-4 is greater than 2). UCI-1-2-3-4 can be added with a CRC check, and then coded and modulated. Then, UCI-1-2-3-4 can be mapped to the multiplexing result PUCCH for transmission.

FIG. 4B shows the multiplexing results for overlapping PUCCHs in FIG. 4A in the first slot. The repetition factor N of the multiplexing result PUCCH can be determined to be equal to the repetition factor of PUCCH1 because its repetition factor is the greatest one among PUCCHs participating in UCI multiplexing. The multiplexing result PUCCH can be transmitted from the first slot and repeated four times in total. Therefore, UCIs of PUCCH2, are transmitted for the additional two times, and the UCIs of PUCCH3 and PUCCH4 are transmitted for the additional three times.

### Embodiment 3

Embodiment 3 can be an improvement based on Embodiment 2, but the UCI multiplexing can be performed on a slot by slot basis. According to the overlap of specific PUCCHs in each slot, UCI multiplexing is performed in each slot respectively. In Embodiment 2, the UCI multiplexing results are determined in the first slot, and then the UCI multiplexing results are repeated in the start slot and the following slots until the correct times of the PUCCHs are transmitted to form the PUCCH repetitions.

In this embodiment, the pre-requisites for PUCCH multiplexing include: more than one PUCCHs are scheduled or configured to start from the (same) slot; these PUCCHs overlap in the time domain in the slot; and at least one of these PUCCHs has a repetition factor greater than 1. When the above conditions are met, UCI multiplexing can be performed for the UCIs in these PUCCHs from or in the (same) slot.

### UCI Types on the Multiplexed PUCCHs

According to one implementation, the type of UCI may be a factor in determining whether to perform UCI or PUCCH multiplexing. According to one implementation, the PUCCH multiplexing is conditioned on the UCI types in PUCCHs participating in UCI multiplexing are the same. For example, types of UCI can be defined by the content(s) it carries. For example, PUCCHs carry HARQ-ACK (Acknowledgement), CSI (Channel Status Information), or SR (Scheduling Request).

Alternatively or additionally, the types of UCI in PUCCHs participating in UCI multiplexing may be different (or are all different from each other). For example, the PUCCH multiplexing can be performed between an HARQ-ACK PUCCH and an SR PUCCH, between an HARQ-ACK PUCCH and CSI PUCCH, between an HARQ-ACK PUCCH, an SR PUCCH and a CSI PUCCH, or between an SR PUCCH and CSI PUCCH.

Alternatively or additionally, the PUCCHs participating in the multiplexing include UCIs of the same types (e.g., a first type) and further include UCI of a different type (e.g., a second type). In this way, PUCCHs of the same type of UCI are multiplexed as a group first, and then one or more interim multiplexing resulted PUCCHs are obtained. Two or more interim multiplexing resulted PUCCHs can be multiplexed with each other to obtain the final resulted PUCCH. Alternatively or additionally, one or more interim resulted PUCCHs can be multiplexed with an original PUCCH that have not been multiplexed due to its different UCI type to generated the final resulted PUCCH.

### The Repetition Factor of Resulted PUCCH(s)

Because the UCI multiplexing is performed on a slot by slot basis in this embodiment, the resulted PUCCH is transmitted in its own slot. The repetition factor of the resulted PUCCH is 1; that is, the resulted PUCCH does not have a repetition factor. In the next or following slots, UCI multiplexing can be re-performed for its own, while the same multiplexing resulted is obtained if the PUCCHs participating in UCI multiplexing does not change. In other cases, the multiplexing result can be different in the following slots as the original participating PUCCHs can be different.

In addition, the resulted PUCCH may be one of the PUCCHs participating in UCI multiplexing; alternatively, the resulted PUCCH can be a new PUCCH that is different from the PUCCHs participating in UCI multiplexing.

### Time Slots of the PUCCH Repetitions

Because the UCI multiplexing is performed on a slot by slot basis in this embodiment, the resulted PUCCH is transmitted in its own slot. The repetition factor of the resulted PUCCH is 1; that is, the resulted PUCCH does not have a repetition factor. There is no need to specifically assign the time slot for the repetitions. Therefore, the slots for the remaining repetitions determined according to the PUCCHs participating in UCI multiplexing can be disregarded.

### UCI Multiplexing in the Slot

In some examples, the UCIs may be divided into two types: UCI of a high physical layer priority or UCI of a low physical layer priority. The PUCCHs of the UCIs may have the same or different repetition factors. The multiplexing can be performed according to the following exemplary methods.

### Method 1

S11: UCI multiplexing is first performed for PUCCHs of UCIs within the same physical layer priority.
S11-1: UCIs in the PUCCHs with a high physical layer priority and the same repetition factor can be concatenated to obtain one or more UCI bits sequences respectively for different repetition factors, H₁, H₂, H₃, . . . Hᵢ (i being the number of UCI bits sequences and i being equal to the number of different repetition factors for UCIs with high physical layer priority). For example, if the PUCCH in a time slot have either repetition factors N equal to 2 or 4 for UCIs of a high priority. The UCIs with a high priority of N=2 would be concatenated to obtain H₁; the rest of UCIs with a high priority of N=4 would be concatenated to obtain H₂. If there is no UCI of a high priority, this step may be skipped. In another example, if there is only one PUCCH of a specific repetition factor, like N=1 (for example), this step can be skipped for this repetition factor (N=1), and be performed only on those UCI groups having multiple PUCCHs of the same repetition factors. In one example, the original UCI (N=1) can serve as H₁. In another example, the concatenated sequences can only be H₁, H₂ (for N=2 and N=4 respectively) for example, if the only PUCCHs are of two repetition factors 2 and 4.

Optionally, interim resulted PUCCHs can be obtained by mapping the sequences to H₁, H₂, H₃, . . . Hᵢ PUCCH resources. In this case, the interim PUCCH of different repetitions factors can be used for the operation for the following steps. For example, the interim PUCCH of different repetitions factors can be multiplexed in the following steps.

Likewise, UCIs in the PUCCHs with low physical layer priority and the same repetition factor can be concatenated to obtain one or more UCI bits sequences, L₁, L₂, L₃ . . . Lⱼ (j being the number of UCI bits sequences, and j being equal to the number of different repetition factors for UCIs with low physical layer priority). For example, if the PUCCH in a time slot have either repetition factors N equal to 2 or 4 for UCIs of a low priority. The UCIs with a low priority of N=2 would be concatenated to obtain L₁; the rest of UCIs with a high priority of N=4 would be concatenated to obtain L₂. If there is no UCI of a low priority, this step may be skipped. In another example, if there is only one PUCCH of a specific repetition factor, like N=1 (for example), this step can be skipped for this repetition factor (N=1), and to be performed only on those UCI groups having multiple PUCCHs of the same repetition factors. In one example, the original UCI can serve as L₁. In another example, the concatenated sequences can only be L₁, L₂ (for N=2 and N=4 respectively) for example, if the only PUCCHs are of two repetition factors 2 and 4.

Optionally, interim PUCCHs can be obtained by mapping the sequence L₁, L₂, L₃ . . . Lⱼ to PUCCH resources. In this case, the interim PUCCH of different repetitions factors can be used for the operation for the following steps. For example, the interim PUCCH of different repetitions factors can be multiplexed in the following steps.

S11-2: If there are PUCCHs with high physical layer priority UCIs but different repetition factors (optionally, including the obtained resulted PUCCHs from S11-1), then the sequence H₁, H₂, H₃, . . . Hᵢ (if obtained from S11-1) are concatenated to obtain the UCI bits sequence, recorded as sequence E1 (optionally, including the resulted PUCCHs obtained from S11-1). For example, when the result sequences H₁, H₂, H₃, . . . Hᵢ from the previous step exit, these existing sequences would be concatenated. It should be noted that there can be only one sequence (in a case when there is only UCIs in the time slot of the same repetition factor), and in this case, this step S11-2 can be skipped for the UCI of this specific priority. In the case when this step is skipped, there is no sequence El generated in this step.

Likewise, if there are PUCCHs with low physical layer priority UCIs but different repetition factors (optionally, including the obtained resulted PUCCHs from S11-1), then L₁, L₂, L₃, . . . Lⱼ are concatenated to obtain the UCI bits sequence, which is recorded as sequence E0. For example, the result sequences L₁, L₂, L₃, . . . Lⱼ from the previous step exit, these existing sequences would be concatenated. It should be noted that there can be only one sequence (in a case when there is only UCIs in the time slot of the same repetition factor), and in this case, this step S11-2 can be skipped for the UCI of this specific priority. In the case when this step is skipped, there is no sequence E0 generated in this step.

S11-3: UCI multiplexing is performed for PUCCHs of UCIs with different physical layer priorities (including the resulted PUCCHs output in the previous step).

If E0 and E1 exist (meaning that for both priorities, there are UCIs of different repetition factors), E0 and E1 are coded and modulated respectively to obtain the data to be transmitted. The data (resulted UCI) can be mapped to the final resulted PUCCH for transmission.

If E1 exists and E0 does not exist (meaning that UCIs of a low priority have only a same repetition factor), Lⱼ (where j=1) and E1 are coded and modulated (optionally including CRC check encoding) respectively to obtain the data to be transmitted.

If E0 exists and E1 does not exist, Hi (where i=1) and E0 are coded and modulated (optionally including CRC check encoding) respectively to obtain the data to be transmitted.

If neither E0 or E1 exist, Hᵢ and Lⱼ (where i and j are equal to 1, meaning that UCIs of the high priority and the low priority have only a same repetition factor) are coded and modulated respectively to obtain the data to be transmitted.

Briefly speaking, the UCIs in the PUCCHs in a same time slot is categorized based on their physical layer priorities. In each priority, the UCIs of the PUCCHs of the same repetition factors are concatenated to form the corresponding sequences for each repetition factors in each priority layer (the sequences H and sequences J). If there is only one PUCCH of a repetition factor, the single UCI may not be concatenated according to one example. Then, for each physical layer priory, the sequences H or sequences J are concatenated respectively to form E1 and E0. If there is only one sequence for a physical layer priority, the concatenating would not be performed. Then, the resulted sequences (either sequence H₁ or E1 for the high priority and either sequence L₁ or E0 for the low priority) of each physical layer priority would be encoded and modulated respectively to obtain the data to be transmitted in the resulted PUCCH in the current time slot. In one example, if all UCIs in such slot are of the same physical layer priority, only the steps for the exiting physical layer priority need to be performed, and the modulation and encoding would be performed on the sequence generated only for such physical layer priority.

### Method 2

S12: UCI multiplexing is first performed for PUCCHs of UCIs with the same physical layer priority.

S12-1: UCIs in the PUCCHs with a high physical layer priority and the same repetition factor can be concatenated to obtain one or more UCI bits sequences respectively for different repetition factors, H₁, H₂, H₃, . . . Hᵢ (i being the number of UCI bits sequences and i being equal to the number of different repetition factors for UCIs with high physical layer priority). For example, if the PUCCH in a time slot have either repetition factors N equal to 2 or 4 for UCIs of a high priority. The UCIs with a high priority of N=2 would be concatenated to obtain H₁; the rest of UCIs with a high priority of N=4 would be concatenated to obtain H₂. If there is no UCI of a high priority, this step may be skipped. In another example, if there is only one PUCCH of a specific repetition factor, like N=1 (for example), this step can be skipped for this repetition factor (N=1), and be performed only on those UCI groups having multiple PUCCHs of the same repetition factors. In one example, the original UCI (N=1) can serve as H₁. In another example, the concatenated sequences can only be H₁, H₂ (for N=2 and N=4 respectively) for example, if the only PUCCHs are of two repetition factors 2 and 4.

Optionally, interim resulted PUCCHs can be obtained by mapping the sequences to H₁, H₂, H₃, . . . Hᵢ PUCCH resources.

Likewise, UCIs in the PUCCHs with low physical layer priority and the same repetition factor can be concatenated to obtain one or more UCI bits sequences, L₁, L₂, L₃ . . . Lⱼ (j being the number of UCI bits sequences, and j being equal to the number of different repetition factors for UCIs with low physical layer priority). For example, if the PUCCH in a time slot have either repetition factors N equal to 2 or 4 for UCIs of a low priority. The UCIs with a low priority of N=2 would be concatenated to obtain L₁; the rest of UCIs with a high priority of N=4 would be concatenated to obtain L₂. If there is no UCI of a low priority, this step may be skipped. In another example, if there is only one PUCCH of a specific repetition factor, like N=1 (for example), this step can be skipped for this repetition factor (N=1), and to be performed only on those UCI groups having multiple PUCCHs of the same repetition factors. In one example, the original UCI can serve as L₁. In another example, the concatenated sequences can only be L₁, L₂ (for N=2 and N=4 respectively) for example, if the only PUCCHs are of two repetition factors 2 and 4.

Optionally, interim PUCCHs can be obtained by mapping the sequence L₁, L₂, L₃ . . . Lⱼ to PUCCH resources.

S12-2: If there are PUCCHs with high physical layer priority UCIs but different repetition factors (optionally including the obtained resulted PUCCHs from S12-1), each sequence H in the Hi is kept unchanged (meaning there is no concatenating in this example).

Likewise, if there are PUCCHs with low physical layer priority UCIs but different repetition factors (including the obtained resulted PUCCHs), each sequence L in Lⱼ is kept unchanged (meaning there is no concatenating in this example).

S12-3: UCI multiplexing is performed for PUCCHs of UCIs with different physical layer priorities (optionally including the resulted PUCCHs output in the previous step).

Each H in Hᵢ (if any) and each L in Lⱼ (if any) are coded and modulated (optionally including CRC check encoding and modulation) respectively to obtain the data to be transmitted. The obtained data to be transmitted is multiplexed in the same resulted PUCCH.

### EXAMPLES

The following PUCCHs overlap in the time domain and have the same starting slot.

PUCCH1 and PUCCH2 have a repetition factor 4 and a high physical layer priority;

PUCCH3 and PUCCH4 have a repetition factor 2 and a high physical layer priority;

PUCCH5 and PUCCH6 have a high physical layer priority but no repetition factor (or repetition factor is 1);

PUCCH7 and PUCCH8 have a repetition factor 4 and a low physical layer priority;

PUCCH9 and PUCCH10 have a repetition factor 2 and a low physical layer priority; and

PUCCH11 and PUCCH12 have a low physical layer priority and no repetition factor (or repetition factor is 1).

Based on the above multiplexing rules, in this starting slot, UCI multiplexing can be performed for these PUCCHs as follows:

Based on method 1, UCI multiplexing for PUCCHs of UCIs with the same physical layer priority includes the following actions:

UCIs in PUCCH1 and PUCCH2 are concatenated to obtain UCI-1-2 because they have high physical layer priority and the same repetition factor;

UCIs in PUCCH3 and PUCCH4 are concatenated to obtain UCI-3-4 because they have high physical layer priority and the same repetition factor;

UCIs in PUCCH5 and PUCCH6 are concatenated to obtain UCI-5-6 because they have high physical layer priority and the same repetition factor;

UCIs in PUCCH7 and PUCCH8 are concatenated to obtain UCI-7-8 because they have low physical layer priority and the same repetition factor;

UCIs in PUCCH9 and PUCCH10 are concatenated to obtain UCI-9-10 because they have low physical layer priority and the same repetition factor;

UCIs in PUCCH11 and PUCCH12 are concatenated to obtain UCI-11-12 because they have low physical layer priority and the same repetition factor;

UCI-1-2, UCI-3-4 and UCI-5-6 are concatenated to obtain sequence E1 of high physical layer priority to be transmitted; and

UCI-7-8, UCI-9-10 and UCI-11-12 are concatenated to obtain sequence E0 of low physical layer priority to be transmitted.

Based on method 1, UCI multiplexing for PUCCHs of UCIs with the different physical layer priorities includes the following steps:

Sequence E1 and sequence E0 are (with optional CRC check) coded and modulated respectively to obtain data-1-2-3-4-5-6 and data-7-8-9-10-11-12 to be transmitted. Data-1-2-3-4-5-6 and data-7-8-9-10-11-12 are mapped to the same resulted PUCCH-1-2-3-4-5-6-7-8-9-10-11-12. Based on the operation in Embodiment 3, PUCCH-1-2-3-4-5-6-7-8-9-10-11-12 does not have a repetition factor. Based on the operation of Embodiment 2, the PUCCH-1-2-3-4-5-6-7-8-9-10-11-12 repetition factor is 4.

Alternatively or additionally, if UCIs with different physical layer priorities are not supported to be multiplexed in the same PUCCH, then data-1-2-3-4-5-6 and data-7-8-9-10-11-12 can respectively obtain the resulted PUCCH (where one is the high physical layer priority, and the other is the low physical layer priority).

Based on method 2, UCI multiplexing for PUCCHs of UCIs with the same physical layer priority includes the following steps:

UCIs in PUCCH1 and PUCCH2 are concatenated to obtain UCI-1-2 because they have high physical layer priority and the same repetition factor;

UCIs in PUCCH3 and PUCCH4 are concatenated to obtain UCI-3-4 because they have high physical layer priority and the same repetition factor;

UCIs in PUCCH5 and PUCCH6 are concatenated to obtain UCI-5-6 because they have high physical layer priority and the same repetition factor.

UCIs in PUCCH7 and PUCCH8 are concatenated to obtain UCI-7-8 because they have low physical layer priority and the same repetition factor;

UCIs in PUCCH9 and PUCCH10 are concatenated to obtain UCI-9-10 because they have low physical layer priority and the same repetition factor; and

UCIs in PUCCH11 and PUCCH12 are concatenated to obtain UCI-11-12 because they have low physical layer priority and the same repetition factor.

Based on method 2, UCI multiplexing for PUCCHs of UCIs with the different physical layer priorities includes the following steps:

UCI-1-2, UCI-3-4, UCI-5-6, UCI-7-8, UCI-9-10 and UCI-11-12 are (with optional CRC check respectively) encoded and modulated respectively to obtain data-1-2, data-3-4, data-5-6, data-7-8, data-9-10 and data-11-12. Then data-1-2, data-3-4, data-5-6, data-7-8, data-9-10 and data-11-12 are mapped to the same resulted PUCCH-1-2-3-4-5-6-7-8-9-10-11-12. Based on the operation in Embodiment 3, PUCCH-1-2-3-4-5-6-7-8-9-10-11-12 does not have a repetition factor. Based on the operation of Embodiment 2, the PUCCH-1-2-3-4-5-6-7-8-9-10-11-12 repetition factor is 4.

Likewise, If UCIs with different physical layer priorities are not supported to be multiplexed in the same PUCCH, then data-1-2, data-3-4, and data-5-6 are multiplexed in the same resulted PUCCH-1-2-3-4-5-6, and data-7-8, data-9-10 and data-11-12 are multiplexed in the same resulted PUCCH-7-8-9-10-11-12.

Further examples are provided as follows.

### Case 1: UCIs in the PUCCHs Only Have the Same Physical Layer Priority in One Slot

If the UCIs in PUCCHs participating in UCI multiplexing have the same physical layer priority, these UCI bits can be cascaded to obtain sequence A, and then (optionally to add a unified CRC check) sequence A is coded and modulated to obtain the data to be transmitted in the resulted PUCCH. For example, the UCIs in multiple PUCCHs with repetition factor N1 have high (or low) priority respectively, and one of their repetitions overlaps in a slot in time domain.

If sequence A is 1~2 bits, the sequence A can be directly modulated to the agreed sequence according to the PUCCH format of the resulted (for example, PUCCH format 1), so the sequence modulated with sequence A is the data to be transmitted. Alternatively or additionally, if the sequence A is 1 to 2 bits, a sequence can be obtained by looking up the predefined table according to the value status of sequence A (for example, PUCCH format 0), so the obtained sequence is the data to be transmitted.

### Case 2: UCIs in the Two PUCCHs Have the Different Physical Layer Priorities in One Slot

If the UCIs in two PUCCHs have different physical layer priorities, then the UCIs bits with different physical layer priorities (with optional CRC check respectively) are coded and modulated respectively, and then mapped to the same resulted PUCCH for transmission. For example, the UCI in a PUCCH with a repetition factor N1 has a high priority, and the UCI in a PUCCH with a repetition factor N2 has a low priority. One of their repetitions overlaps in a slot in time domain.

### Case 3: UCIs in the PUCCHs Have the Same and Different Physical Layer Priorities in One Slot

In this case, some UCIs in PUCCHs with the same repetition factor. But one or more of them have a high priority, and one or more of them have a low priority. One of their repetitions overlaps in a slot in time domain.

UCI multiplexing can be performed first between PUCCHs of UCIs with the same physical layer priority to obtain the resulted PUCCH (PUCCH-a). The resulted PUCCH-a here may include two PUCCHs, one includes the resulted PUCCH for PUCCHs of UCIs with low physical layer priority (PUCCH-al), and the other includes the resulted PUCCH for PUCCHs of UCIs with high physical layer priority (if any, recorded as PUCCH-ah).

Then UCI multiplexing is performed between PUCCHs of UCIs with different physical layer priorities overlapped in time domain (including the resulted PUCCH-a if the resulted PUCCH-a overlaps with PUCCH with different priorities in time domain) to obtain resulted PUCCH-b. PUCCH-b may also include multiple PUCCHs. The resulted PUCCH-b can be transmitted as the final resulted PUCCH. PUCCH-b also has the same repetition factor N1 or N2, and is transmitted from slot n. In one example, the physical layer priority of the resulted PUCCH can be equal to the highest physical layer priority among the physical layer priority of UCIs participating in UCI multiplexing.

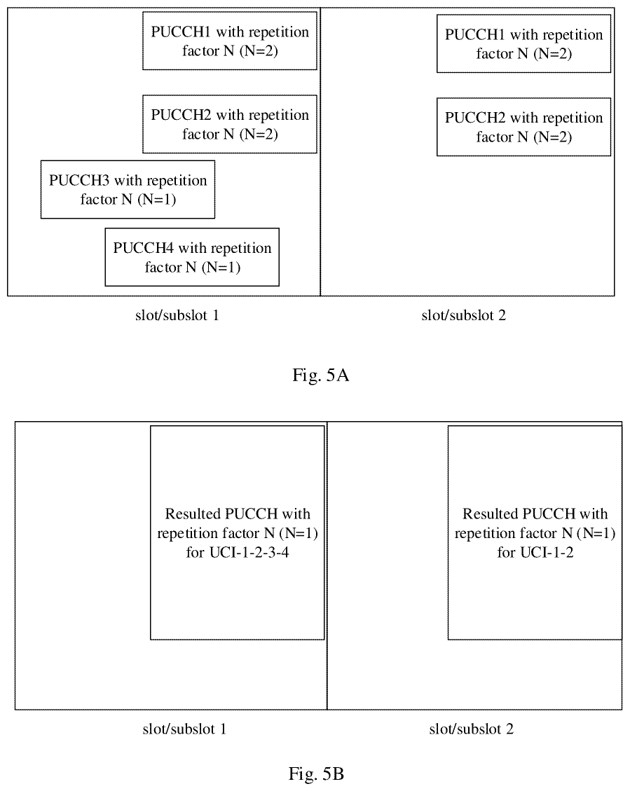

Referring to FIG. 5A as an example, PUCCH1 and PUCCH2 are scheduled here to start transmission in the first slot. PUCCH1 and PUCCH2 have the same repetition factor N (N=2). PUCCH3 and PUCCH4 are also scheduled in the first slot, and PUCCH3 and PUCCH4 have a repetition factor M (M=1), meaning that, PUCCH3 and PUCCH4 are not transmitted repeatedly. These PUCCHs overlap in the time domain and meet the multiplex timeline. As the above conditions are met, UCI multiplexing can be performed for UCIs in these PUCCHs. It is assumed that these PUCCHs have the same physical layer priority. The details are as follows:

In the first slot, the UCIs bits corresponding to PUCCH1, PUCCH2, PUCCH3, and PUCCH4 are concatenated to obtain a bit sequence UCI-1-2-3-4 (assuming that the number of bits of UCI-1-2-3-4 is greater than 2). UCI-1-2-3-4 is added with a CRC check, then coded and modulated. Then UCI-1-2-3-4 is mapped to the resulted PUCCH for transmission.

In the second slot, the UCIs bits corresponding to PUCCH1 and PUCCH2 are concatenated to obtain the bit sequence UCI-1-2 (assuming that the number of bits of UCI-1-2 is greater than 2). UCI-1-2 is added with a CRC check, coded and modulated, and then mapped to the resulted PUCCH for transmission.

FIG. 5B shows the multiplexing results for overlapping PUCCHs in FIG. 5A. Here, the UCI multiplexing can be performed on a slot by slot basis, and the multiplexing result PUCCH is transmitted only in the corresponding slot.

### Embodiment 4

The prerequisites for the UCI multiplexing in this embodiment may include the following conditions: There are multiple PUCCHs with time domain overlaps in one slot, and at least one of them has a repetition factor greater than 1. When the above conditions are met, the UCI multiplexing may be performed for UCIs in the multiple PUCCHs in the specific slot. For simplicity, assume that the UCIs in the multiple PUCCHs have the same physical layer priority, but UCIs with different physical layer priorities can be encoded and modulated separately and mapped to the PUCCH for transmission as this disclosure explained in the other embodiments. The detailed operations may include the following. In this embodiment, the PUCCH multiplexing can also be performed on a slot by slot basis. Briefly speaking, the following process will be performed for the respective PUCCHs that meet their respectively requirement in the same slot, and then the resulted PUCCH can be generated in the time slot. The resulted PUCCH would be transmitted in the original slot.

Process 1: For PUCCHs with the same repetition factor:

For PUCCHs (if any) with the same start slot and the same repetition factor R (R>1) in this slot, the UCI bits in these PUCCHs can be concatenated (added with an optional CRC check) and encoded and modulated to obtain the data to be transmitted. These data are multiplexed in the same multiplexing result PUCCH, and the resulted PUCCH can be transmitted in this slot. This slot for transmission may not be the start slot of these PUCCHs.

Process 2: For PUCCHs without repetition factor:

For PUCCHs without repetition factor, if any, in this slot, the UCI bits in these PUCCHs can be concatenated (added an optional CRC check) and encoded and modulated to obtain the data to be transmitted. These data can be multiplexed in the same resulted PUCCH, and the resulted PUCCH is transmitted in this slot.

Process 3: For the rest of the PUCCH PUCCHs

Process 3 may include three different processes: Process 3-1, Process 3-2, and Process 3-3.

Process 3-1. In this slot (except for the PUCCHs processed in Process 1 and Process 2), for PUCCHs with different start slots or PUCCHs with different repetition factors, the UCI bits in these PUCCHs can be (added with an optional CRC check respectively) encoded and modulated respectively to obtain the data to be transmitted. These data are multiplexed in the same resulted PUCCH, and the resulted PUCCH can be transmitted in this slot.

Process 3-2. Alternatively or additionally, in this slot (except for PUCCHs processed in Process 1 and Process 2), for PUCCHs with different start slots or PUCCHs with different repetition factors, the UCI bits in these PUCCHs can be concatenated (added with an optional CRC check) and encoded and modulated to obtain the data to be transmitted. These data can be multiplexed in the same resulted PUCCH, and the resulted PUCCH is transmitted in this slot.

Process 3-3. Alternatively or additionally, in this slot (except for the PUCCHs processed in Process 1 and Process 2), for PUCCHs with different start slots or PUCCHs with different repetition factors, then the UCI bits in these PUCCHs can be dropped and these PUCCHs are not transmitted.

Once the process above are performed or skipped for no eligible PUCCH, the data obtained from process 1, process 2, and process 3 can be multiplexed in the same resulted PUCCH based on an order of: (1) process 1, following by process 2, following by process 3; or (2) process 1, following by process 3, following by process 2.

According to one implementation in the concatenating of the above process in this or other embodiments of this disclosure, the different types of UCI bits can be concatenated according to the order of HARQ-ACK, following by SR, following by CSI. The same type of UCI can be concatenated based on a sequence of a small to large sizes according to the starting symbol index of the PUCCH. For PUCCHs with the same starting symbol, the order of the is from a larger number of symbols to a smaller number of symbols according to the number of symbols in the PUCCH. The data obtained by encoded and modulated separately can be multiplexed in the same resulted PUCCH according to the order of the HARQ-ACK, SR, CSI.

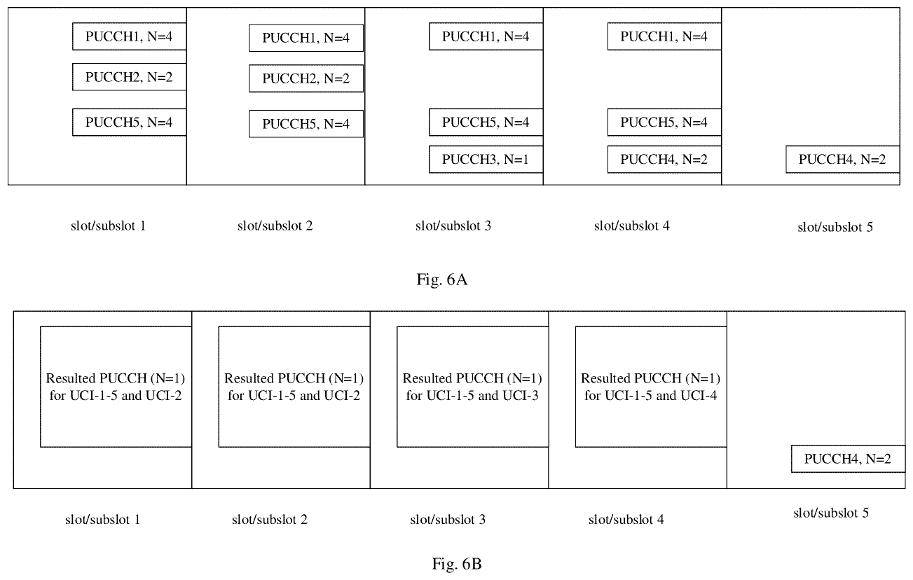

Referring to FIG. 6A, the repetition factor of PUCCH1 and PUCCH5 is 4 and the starting slot is the first slot, and it is assumed that the subsequent slots of PUCCH1 and PUCCH5 are determined as shown in FIG. 6A. The repetition factor of PUCCH2 is 2 and the starting slot is the first slot, and it is assumed that the subsequent slot of PUCCH2 are determined as shown in FIG. 6A. PUCCH3 has no repetition factor (or the repetition factor is 1) and the starting slot is the third slot. The repetition factor of PUCCH4 is 2 and the starting slot is the fourth slot (from the left), and it is assumed that the subsequent slot of PUCCH4 is determined as shown in FIG. 6A. Using FIG. 6A as an example, UCI multiplexing can be performed as follows for these PUCCHs.

In the first slot (from the left), there are PUCCH1, PUCCH2, and PUCCH5. PUCCH1 and PUCCH5 have the same start slot and the same repetition factor. Therefore, the UCIs in PUCCH1 and PUCCH5 are concatenated to obtain UCI-1-5 according to process 1. The UCI-1-5 are encoded and modulated to obtain the data-1-5. PUCCH2 meets process 3. If PUCCH2 is processed according to process 3-1, the UCIs in PUCCH2 results in UCI-2. The UCI-2 are encoded and modulated to obtain the data data-2. Data-2 and data-1-5 can be multiplexed in the same resulted PUCCH, and the resulted PUCCH is transmitted in the slot.

Alternatively, if PUCCH2 is processed according to process 3-2, the UCIs in PUCCH2 results in UCI-2. The UCI-2 are encoded and modulated to obtain the data data-2. Data-2 and data-1-5 are multiplexed in the same resulted PUCCH, and the resulted PUCCH is transmitted in the slot. As it is shown, if only one PUCCH is processed according to process 3-1 and process 3-2 respectively, the results are the same.

Alternatively, if PUCCH2 is processed according to process 3-3, then PUCCH2 is not transmitted, and the UCIs in PUCCH2 are not multiplexed. Data-1-5 is multiplexed in the same resulted PUCCH, and the resulted PUCCH is transmitted in the slot.

In the second slot (from the left), there are PUCCH1, PUCCH2, and PUCCH5. The same process as that in the first slot is performed. The resulted PUCCH is transmitted in the second slot.

In the third slot, there are PUCCH1, PUCCH3, and PUCCH5. PUCCH1 and PUCCH5 have the same start slot (starting from the first slot in FIG. 6A) and the same repetition factor (N=4). Therefore, the UCIs in PUCCH1 and PUCCH5 can be concatenated to obtain UCI-1-5 according to process 1. The UCI-1-5 are encoded and modulated to obtain the data-1-5. PUCCH3 meets process 3. If PUCCH3 is processed according to process 3-1, the UCIs in PUCCH3 results in UCI-3. The UCI-3 is encoded and modulated to obtain the data data-3. Data-3 and data-1-5 are multiplexed in the same resulted PUCCH, and the resulted PUCCH is transmitted in the third slot.

Alternatively, if PUCCH3 is processed according to process 3-2, the UCIs in PUCCH3 results in UCI-3. The UCI-3 is encoded and modulated to obtain the data-3. Data-3 and data-1-5 are multiplexed in the same resulted PUCCH, and the resulted PUCCH is transmitted in the third slot.

Alternatively, if PUCCH3 is processed according to process 3-3, then PUCCH3 is not transmitted, and the UCIs in PUCCH3 are not multiplexed. Data-1-5 is multiplexed in the same resulted PUCCH, and the resulted PUCCH is transmitted in the third slot.

In the fourth slot, there are PUCCH1, PUCCH4, and PUCCH5. PUCCH1 and PUCCH5 have the same start slot (starting from the first slot in FIG. 6A) and the same repetition factor. Therefore, the UCIs in PUCCH1 and PUCCH5 are concatenated to obtain UCI-1-5 according to process 1. The UCI-1-5 are encoded and modulated to obtain the data-1-5. PUCCH4 meets process 3. If PUCCH4 is processed according to processing 3-1, the UCIs in PUCCH4 results in UCI-4. The UCI-4 are encoded and modulated to obtain the data data-4. Data-4 and data-1-5 are multiplexed in the same resulted PUCCH, and the resulted PUCCH is transmitted in the fourth slot.

Alternatively, if PUCCH4 is processed according to process 3-2, the UCI in PUCCH4results in UCI-4. The UCI-4 is encoded and modulated to obtain the data data-4. Data-4 and data-1-5 are multiplexed in the same resulted PUCCH, and the resulted PUCCH is transmitted in the fourth slot.

Alternatively, if PUCCH4 is processed according to processing 3-3, then PUCCH4 is not transmitted, and the UCIs in PUCCH4 are not multiplexed. Data-1-5 is multiplexed in the same resulted PUCCH, and the resulted PUCCH is transmitted in the fourth slot.

In the fifth slot in FIG. 6A, there is only one PUCCH4, and no PUCCH overlaps in the time domain. Therefore, PUCCH4 is transmitted and UCI multiplexing does not need to be performed.

For the overlap of PUCCHs in FIG. 6A, after performing UCI multiplexing, the resulted PUCCHs is shown in FIG. 6B. The UCIs in PUCCH1 and PUCCH5 are transmitted 4 times repeatedly to meet their requirements (to follow the greatest repetition factors of the multiplexed PUCCHs). The UCI in PUCCH2 and PUCCH4 is transmitted twice respectively to meet their requirements. The UCI in PUCCH3 is transmitted once, which also meets the requirements.

According to one example of this disclosure, a wireless communication method is provided. The method includes: determining a plurality of PUCCHs overlap in time domain and at least one of the plurality of PUCCHs has a repetition factor greater than 1; multiplexing multiple pieces of uplink control information (UCI) of the plurality of PUCCHs to obtain a resulted PUCCH if a predefined condition being satisfied; and transmitting the resulted PUCCH to a base station.

According to one implementation of the disclosed wireless communication methods, the predefined condition includes the plurality of PUCCHs have a same repetition factor and a same start slot; or the plurality of PUCCHs respectively have repetitions and use the same slots.

According to one implementation of the disclosed wireless communication methods, the predefined condition includes that the plurality of PUCCHs have the same start slot and at least one of the plurality of PUCCHs has a repetition factor greater than 1.

According to one implementation of the disclosed wireless communication methods, a repetition factor of the resulted PUCCH is either one of: a greatest repetition factor of the plurality of PUCCHs associated with the multiple pieces of UCI; or a repetition factor configured by signaling for the resulted PUCCH.

According to one implementation of the disclosed wireless communication methods, each of the multiple pieces of UCI carries at least one type of the following carried information: acknowledgment, Scheduling Request (SR), or channel state information (CSI).

According to one implementation of the disclosed wireless communication methods, each piece of the UCI includes a same type of the carried information.

According to one implementation of the disclosed wireless communication methods, each piece of the UCI carried includes different types of the carried information.

According to one implementation of the disclosed wireless communication methods, multiplexing multiple pieces of UCI to obtain a resulted PUCCH includes: multiplexing a first group of UCI having a same first type of carried information to obtain an interim UCI; and multiplexing the interim UCI and one or more pieces of extra UCI having a second type of carried information different from the first type of carried information to obtain resulted data to be carried by the resulted PUCCH.

According to one implementation of the disclosed wireless communication methods, the method further includes determining one or more slots for transmission of the resulted PUCCH, wherein the one or more slots meet the conditions that the one or more slots include a uplink symbol or flexible symbol consistent with a starting symbol configured for the resulted PUCCH and that the one or more slots include consecutive uplink symbols or flexible symbols greater than or equal to a number of the symbols of the resulted PUCCH.

According to one implementation of the disclosed wireless communication methods, multiplexing multiple pieces of UCI of the plurality of PUCCHs to obtain a resulted PUCCH includes: multiplexing a first group of UCI of a first physical layer priority to obtain an interim UCI; and multiplexing a second group of UCI of a second physical layer priority to obtain an interim UCI; multiplexing the interim UCI obtained from the first physical layer priority and second physical layer priority to obtain resulted data to be carried by the resulted PUCCH.

According to one implementation of the disclosed wireless communication methods, multiplexing multiple pieces of UCI of the plurality of PUCCHs to obtain a resulted PUCCH includes: concatenating the multiple pieces of UCI to obtain an interim sequence; and encoding and modulating the interim sequence to obtain resulted data, wherein the multiple pieces of UCI have a same physical layer priority and PUCCHs associated with the multiple pieces of UCI have a same repetition factor and are scheduled to have a time overlap.

According to one implementation of the disclosed wireless communication methods, encoding and modulating the interim sequence to obtain the resulted data comprising at least one of: modulating the interim sequence according to a format of the resulted PUCCH and a predetermined sequence, wherein the interim sequence has 1~2 bits; or modulating the interim according to a look up table and a format of the resulted PUCCH, wherein the interim sequence has more than 1~2 bits.

According to one implementation of the disclosed wireless communication methods, encoding and modulating the interim sequence to obtain the resulted data includes modulating the interim sequence for a CRC check when the interim sequence has more than 2 bits.

According to one implementation of the disclosed wireless communication methods, multiplexing multiple pieces of UCI to obtain a resulted PUCCH includes: modulating and encoding one or more pieces of UCI of a first physical layer priority to obtain first interim data; modulating and encoding one or more pieces of UCI of a second physical layer priority to obtain second interim data; and mapping the first interim data and the second interim data to obtain the resulted PUCCH.

According to one implementation of the disclosed wireless communication methods, multiplexing multiple pieces of UCI to obtain a resulted PUCCH further includes modulating and encoding the one or more pieces UCI of the first or second physical layer priorities for a CRC check.

According to one implementation of the disclosed wireless communication methods, multiplexing multiple pieces of UCI to obtain a resulted PUCCH includes: multiplexing one or more pieces of UCI of a first physical layer priority to obtain one or more first interim PUCCHs; multiplexing one or more pieces of UCI of a second physical layer priority to obtain one or more second interim PUCCHs; and multiplexing the one or more first interim PUCCH and second interim PUCCH to obtain the resulted PUCCH.

According to one implementation of the disclosed wireless communication methods, the physical layer priority of the one or more PUCCHs is the highest physical layer priority among the first and second physical layer priorities.

According to one implementation of the disclosed wireless communication methods, multiplexing multiple pieces of UCI to obtain the resulted PUCCH includes: multiplexing multiple pieces of UCI in respective slots of PUCCH associated with the multiple pieces of UCI to obtain the resulted PUCCH of the respective slots.

According to one implementation of the disclosed wireless communication methods, transmitting the resulted PUCCH comprising transmitting each of the resulted PUCCH in the respective slots.

According to one implementation of the disclosed wireless communication methods, each of the multiple pieces of UCI carries at least one type of the following carried information: acknowledgement, Scheduling Request (SR), or channel state information (CSI).

According to one implementation of the disclosed wireless communication methods, each piece of the UCI includes a same type of the carried information.

According to one implementation of the disclosed wireless communication methods, each piece of the UCI carried includes different types of the carried information.

According to one implementation of the disclosed wireless communication methods, multiplexing multiple pieces of UCI to obtain a resulted PUCCH includes: multiplexing multiple pieces of UCI of respective types to obtain interim UCI; and multiplexing the multiple interim UCI to obtain resulted data to be carried by the resulted PUCCH.

According to one implementation of the disclosed wireless communication methods, multiplexing multiple pieces of UCI of the plurality of PUCCHs to obtain a resulted PUCCH includes: multiplexing multiple pieces of UCI having same respective physical layer priorities and associated with PUCCH of a same respective repetition factor to obtain one or more respective first interim sequences of respective physical layer priorities and repetition factors.

According to one implementation of the disclosed wireless communication methods, multiplexing multiple pieces of UCI having same respective physical layer priorities and associated with PUCCH of a same respective repetition factor to obtain one or more respective first interim sequences of respective physical layer priorities and repetition factors includes: concatenating the first interim sequences of each repetition factor of the respective physical layer priorities to obtain one or more second interim sequences.

According to one implementation of the disclosed wireless communication methods, multiplexing multiple pieces of UCI having same respective physical layer priorities and associated with PUCCH of a same respective repetition factor to obtain one or more respective first interim sequences of respective physical layer priorities and repetition factors further includes at least one of: modulating and encoding, respectively, at least two of the second interim sequences respectively to obtain resulted data of the resulted PUCCH; modulating and encoding, respectively, the first interim sequence and the second interim sequence to obtain resulted data of the resulted PUCCH; or modulating and encoding, respectively, at least two of first interim sequences to obtain resulted data of the resulted PUCCH.

According to one implementation of the disclosed wireless communication methods, multiplexing multiple pieces of UCI having same respective physical layer priorities and associated with PUCCH of a same respective repetition factor to obtain one or more respective first interim sequences of respective physical layer priorities and repetition factors includes modulating and encoding, respectively, the one or more respective first interim sequences of respective physical layer priorities and repetition factors.

According to one implementation of the disclosed wireless communication methods, multiplexing multiple pieces of UCI having same respective physical layer priorities and associated with PUCCH of a same respective repetition factor to obtain one or more respective first interim sequences of respective physical layer priorities and repetition factors includes: multiplexing, respectively, multiple pieces of UCI having same respective physical layer priorities to obtain respective first interim sequences of respective physical layer priorities; and modulating and encoding, respectively, respective first interim sequences of respective physical layer priorities to obtain resulted data of the resulted PUCCH.

According to one implementation of the disclosed wireless communication methods, multiplexing multiple pieces of uplink control information (UCI) to obtain a resulted PUCCH includes: concatenating a first group of UCI associated with PUCCHs with a same start slot and a same repetition factor to obtain a first interim sequence; and modulating and encoding the interim sequence to obtain first resulted data to be carried by the resulted PUCCH.

According to one implementation of the disclosed wireless communication methods, multiplexing multiple pieces of UCI of the plurality of PUCCHs to obtain a resulted PUCCH further includes: concatenating a second group of UCI associated with PUCCHs in the same slot with the first group of UCI and without a repetition factor to obtain a second interim sequence; and modulating and encoding the second interim sequence to obtain second resulted data to be carried by the resulted PUCCH.

According to one implementation of the disclosed wireless communication methods, multiplexing multiple pieces of UCI of the plurality of PUCCHs to obtain a resulted PUCCH further includes: modulating and encoding, respectively, a third group of UCI associated with a rest of one or more PUCCHs other than the first group of UCI or the second group of UCI in the same slot to obtain third resulted data to be carried by the resulted PUCCH, wherein the rest of the PUCCH have different start slots or different repetitions factor with each other.

According to one implementation of the disclosed wireless communication methods, multiplexing multiple pieces of UCI of the plurality of PUCCHs to obtain a resulted PUCCH further includes: concatenating a third group of UCI associated with a rest of PUCCHs other than the first group of UCI or the second group of UCI in the same slot to obtain a third interim sequence, wherein the rest of the PUCCHs have different start slots or different repetitions factor with each other; and modulating and encoding the third interim sequence to obtain third resulted data carried by the resulted PUCCH.

According to one implementation of the disclosed wireless communication methods, the method further includes disregarding a rest of UCI associated with a rest of PUCCH other than the first group of UCI or the second group of UCI.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
determining a plurality of PUCCHs overlap in time domain and at least one of the plurality of PUCCHs has a repetition factor greater than 1;
multiplexing multiple pieces of uplink control information (UCI) of the plurality of PUCCHs to obtain a resulted PUCCH if a predefined condition being satisfied; and
transmitting the resulted PUCCH to a base station.

2. The method of claim 1, wherein
the predefined condition includes the plurality of PUCCHs have a same repetition factor and a same start slot; or
the plurality of PUCCHs respectively have repetitions and use the same slots; or,
the predefined condition includes that the plurality of PUCCHs have the same start slot and at least one of the plurality of PUCCHs has a repetition factor greater than 1; or,
a repetition factor of the resulted PUCCH is either one of: a greatest repetition factor of the plurality of PUCCHs associated with the multiple pieces of UCI; or a repetition factor configured by signaling for the resulted PUCCH; or,
the method further comprises determining one or more slots for transmission of the resulted PUCCH, wherein the one or more slots meet the conditions that the one or more slots include a uplink symbol or flexible symbol consistent with a starting symbol configured for the resulted PUCCH and that the one or more slots include, starting from the uplink symbol or the flexible symbol, consecutive uplink symbols or flexible symbols greater than or equal to a number of the symbols of the resulted PUCCH; or,
each of the multiple pieces of UCI carries at least one type of the following carried information: acknowledgment, Scheduling Request (SR), or channel state information (CSI).

3. (canceled)

4. (canceled)

5. (canceled)

6. The method of claim 2, wherein
each piece of the UCI includes a same type of the carried information; or,
each piece of the UCI carried includes different types of the carried information; or,
multiplexing multiple pieces of UCI to obtain a resulted PUCCH comprises:
multiplexing a first group of UCI having a same first type of carried information to obtain an interim UCI; and multiplexing the interim UCI and one or more pieces of extra UCI having a second type of carried information different from the first type of carried information to obtain resulted data to be carried by the resulted PUCCH.

7. (canceled)

8. (canceled)

9. (canceled)

10. The method of claim 1, wherein multiplexing multiple pieces of UCI of the plurality of PUCCHs to obtain a resulted PUCCH comprises:
multiplexing a first group of UCI of a first physical layer priority to obtain an first interim UCI; and
multiplexing a second group of UCI of a second physical layer priority to obtain an second interim UCI; and
multiplexing the interim first and second UCI obtained from the first physical layer priority and second physical layer priority to obtain resulted data to be carried by the resulted PUCCH; or,
concatenating the multiple pieces of UCI to obtain an interim sequence; and encoding and modulating the interim sequence to obtain resulted data, wherein: the multiple pieces of UCI have a same physical layer priority; and PUCCHs associated with the multiple pieces of UCI have a same repetition factor and are scheduled to have a time overlap; or,
modulating and encoding one or more pieces of UCI of a first physical layer priority to obtain first interim data; modulating and encoding one or more pieces of UCI of a second physical layer priority to obtain second interim data; and mapping the first interim data and the second interim data to obtain the resulted PUCCH; or,
multiplexing one or more pieces of UCI of a first physical layer priority to obtain one or more first interim PUCCHs; multiplexing one or more pieces of UCI of a second physical layer priority to obtain one or more second interim PUCCHs; and multiplexing the one or more first interim PUCCHs and second interim PUCCHs to obtain the resulted PUCCH; or,
multiplexing multiple pieces of UCI in respective slots of PUCCH associated with the multiple pieces of UCI to obtain the resulted PUCCH of the respective slots; or,
multiplexing multiple pieces of UCI having same respective physical layer priorities and associated with PUCCH of a same respective repetition factor to obtain one or more respective first interim sequences of respective physical layer priorities and repetition factors; or,
concatenating a first group of UCI associated with PUCCHs with a same start slot and a same repetition factor to obtain a first interim sequence; and modulating and encoding the interim sequence to obtain first resulted data to be carried by the resulted PUCCH; and/or, concatenating a second group of UCI associated with PUCCHs in the same slot with the first group of UCI and without a repetition factor to obtain a second interim sequence; and modulating and encoding the second interim sequence to obtain second resulted data to be carried by the resulted PUCCH.

11. (canceled)

12. The method of claim 10, wherein
encoding and modulating the interim sequence to obtain the resulted data comprising at least one of:
modulating the interim sequence according to a format of the resulted PUCCH and a predetermined sequence, wherein the interim sequence has 1~2 bits; or
modulating the interim according to a look-up table and a format of the resulted PUCCH, wherein the interim sequence has more than 1~2 bits; or,
encoding and modulating the interim sequence to obtain the resulted data comprises modulating the interim sequence for a CRC check when the interim sequence has more than 2 bits; or,
multiplexing multiple pieces of UCI to obtain a resulted PUCCH further comprises modulating and encoding the one or more pieces of UCI of the first or second physical layer priorities for a CRC check; or,
the physical layer priority of the one or more PUCCHs is the highest physical layer priority among the first and second physical layer priorities; or,
transmitting the resulted PUCCH comprising transmitting each of the resulted PUCCH in the respective slots; and/or, each of the multiple pieces of UCI carries at least one type of the following carried information: acknowledgement, Scheduling Request (SR), or channel state information (CSI); or,
multiplexing multiple pieces of UCI having same respective physical layer priorities and associated with PUCCH of a same respective repetition factor to obtain one or more respective first interim sequences of respective physical layer priorities and repetition factors comprises: concatenating the first interim sequences of each repetition factor of the respective physical layer priorities to obtain one or more second interim sequences; or,
multiplexing multiple pieces of UCI having same respective physical layer priorities and associated with PUCCH of a same respective repetition factor to obtain one or more respective first interim sequences of respective physical layer priorities and repetition factors comprises modulating and encoding, respectively, the one or more respective first interim sequences of respective physical layer priorities and repetition factors; or,
multiplexing multiple pieces of UCI having same respective physical layer priorities and associated with PUCCH of a same respective repetition factor to obtain one or more respective first interim sequences of respective physical layer priorities and repetition factors comprises: multiplexing, respectively, multiple pieces of UCI having same respective physical layer priorities to obtain respective first interim sequences of respective physical layer priorities; and modulating and encoding, respectively, respective first interim sequences of respective physical layer priorities to obtain resulted data of the resulted PUCCH; or,
multiplexing multiple pieces of UCI of the plurality of PUCCHs to obtain a resulted PUCCH further comprises: modulating and encoding, respectively, a third group of UCI associated with a rest of one or more PUCCHs other than the first group of UCI or the second group of UCI in the same slot to obtain third resulted data to be carried by the resulted PUCCH, wherein the rest of the PUCCH have different start slots or different repetitions factor with each other; or,
multiplexing multiple pieces of UCI of the plurality of PUCCHs to obtain a resulted PUCCH further comprises: concatenating a third group of UCI associated with a rest of PUCCHs other than the first group of UCI or the second group of UCI in the same slot to obtain a third interim sequence, wherein the rest of the PUCCHs have different start slots or different repetitions factor with each other; and modulating and encoding the third interim sequence to obtain third resulted data carried by the resulted PUCCH; or,
the method further comprises disregarding a rest of UCI associated with a rest of PUCCH other than the first group of UCI or the second group of UCI.

13. (canceled)

14. (canceled)

15. (canceled)

16. (canceled)

17. (canceled)

18. (canceled)

19. (canceled)

20. (canceled)

21. The method of claim 12, wherein
each piece of the UCI includes a same type of the carried information; or,
each piece of the UCI carried includes different types of the carried information.

22. (canceled)

23. The method of claim 21, wherein multiplexing multiple pieces of UCI to obtain a resulted PUCCH comprises:
multiplexing multiple pieces of UCI of respective types to obtain multiple pieces of interim UCI; and
multiplexing the multiple pieces of interim UCI to obtain resulted data to be carried by the resulted PUCCH.

24. (canceled)

25. (canceled)

26. The method of claim 12, wherein multiplexing multiple pieces of UCI having same respective physical layer priorities and associated with PUCCH of a same respective repetition factor to obtain one or more respective first interim sequences of respective physical layer priorities and repetition factors further comprises at least one of:
modulating and encoding, respectively, at least two of the second interim sequences respectively to obtain resulted data of the resulted PUCCH;
modulating and encoding, respectively, the first interim sequence and the second interim sequence to obtain resulted data of the resulted PUCCH; or
modulating and encoding, respectively, at least two of first interim sequences to obtain resulted data of the resulted PUCCH.

27. (canceled)

28. (canceled)

29. (canceled)

30. (canceled)

31. (canceled)

32. (canceled)

33. (canceled)

34. A wireless communication method, comprising:
determining a plurality of PUCCHs overlap in time domain and at least one of the plurality of PUCCHs has a repetition factor greater than 1; and
receiving resulted PUCCH that is resulted from multiplexing multiple pieces of uplink control information (UCI) of the plurality of PUCCHs to obtain a resulted PUCCH if a predefined condition being satisfied.

35. The method of claim 34, wherein
the predefined condition includes the plurality of PUCCHs have a same repetition factor and a same start slot; or
the plurality of PUCCHs respectively have repetitions and use the same slots; or,
the predefined condition includes that the plurality of PUCCHs have the same start slot and at least one of the plurality of PUCCHs has a repetition factor greater than 1; or,
a repetition factor of the resulted PUCCH is either one of: a greatest repetition factor of the plurality of PUCCHs associated with the multiple pieces of UCI; or a repetition factor configured by signaling for the resulted PUCCH; or,
the resulted PUCCH is received from one or more slots for transmission, wherein the one or more slots meet the conditions that the one or more slots include an uplink symbol or flexible symbol consistent with a starting symbol configured for the resulted PUCCH and that the one or more slots include consecutive uplink symbols or flexible symbols greater than or equal to a number of the symbols of the resulted PUCCH; or,
each of the multiple pieces of UCI carries at least one type of the following carried information: acknowledgment, Scheduling Request (SR), or channel state information (CSI).

36. (canceled)

37. (canceled)

38. (canceled)

39. The method of claim 35, wherein
each piece of the UCI includes a same type of the carried information; or,
each piece of the UCI carried includes different types of the carried information; or,
multiplexing multiple pieces of UCI to obtain a resulted PUCCH comprises:
multiplexing a first group of UCI having a same first type of carried information to obtain an interim UCI; and multiplexing the interim UCI and one or more pieces of extra UCI having a second type of carried information different from the first type of carried information to obtain resulted data to be carried by the resulted PUCCH.

40. (canceled)

41. (canceled)

42. (canceled)

43. The method of claim 34, wherein multiplexing multiple pieces of UCI of the plurality of PUCCHs to obtain a resulted PUCCH comprises:
multiplexing a first group of UCI of a first physical layer priority to obtain an first interim UCI; and_
multiplexing a second group of UCI of a second physical layer priority to obtain an second interim UCI; and
multiplexing the first and second interim UCI obtained from the first physical layer priority and second physical layer priority to obtain resulted data to be carried by the resulted PUCCH; or,
concatenating the multiple pieces of UCI to obtain an interim sequence; and encoding and modulating the interim sequence to obtain resulted data, wherein the multiple pieces of UCI have a same physical layer priority and PUCCHs associated with the multiple pieces of UCI have a same repetition factor and are scheduled to have a time overlap; or,
modulating and encoding one or more pieces of UCI of a first physical layer priority to obtain first interim data; modulating and encoding one or more pieces of UCI of a second physical layer priority to obtain second interim data; and mapping the first interim data and the second interim data to obtain the resulted PUCCH; or,
multiplexing one or more pieces of UCI of a first physical layer priority to obtain one or more first interim PUCCHs; multiplexing one or more pieces of UCI of a second physical layer priority to obtain one or more second interim PUCCHs; and multiplexing the one or more first interim PUCCHs and second interim PUCCHs to obtain the resulted PUCCH; or,
multiplexing multiple pieces of UCI in respective slots of PUCCH associated with the multiple pieces of UCI to obtain the resulted PUCCH of the respective slots; or,
multiplexing multiple pieces of UCI having same respective physical layer priorities and associated with PUCCH of a same respective repetition factor to obtain one or more respective first interim sequences of respective physical layer priorities and repetition factors; or,
concatenating a first group of UCI associated with PUCCHs with a same start slot and a same repetition factor to obtain a first interim sequence; and modulating and encoding the interim sequence to obtain first resulted data to be carried by the resulted PUCCH; and/or, concatenating a second group of UCI associated with PUCCHs in the same slot with the first group of UCI and without a repetition factor to obtain a second interim sequence; and modulating and encoding the second interim sequence to obtain second resulted data to be carried by the resulted PUCCH.

44. (canceled)

45. The method of claim 43, wherein
encoding and modulating the interim sequence to obtain the resulted data comprising at least one of:
modulating the interim sequence according to a format of the resulted PUCCH and a predetermined sequence, wherein the interim sequence has 1~2 bits; or
modulating the interim according to a look up table and a format of the resulted PUCCH, wherein the interim sequence has more than 1~2 bits; or,
encoding and modulating the interim sequence to obtain the resulted data comprises modulating the interim sequence for a CRC check when the interim sequence has more than 2 bits; or,
multiplexing multiple pieces of UCI to obtain a resulted PUCCH further comprises modulating and encoding the one or more pieces of UCI of the first or second physical layer priorities for a CRC check; or,
the physical layer priority of the one or more PUCCHs is the highest physical layer priority among the first and second physical layer priorities; or,
transmitting the resulted PUCCH comprising transmitting each of the resulted PUCCH in the respective slots; and/or, each of the multiple pieces of UCI carries at least one type of the following carried information: acknowledgement, Scheduling Request (SR), or channel state information (CSI); or,
multiplexing multiple pieces of UCI having same respective physical layer priorities and associated with PUCCH of a same respective repetition factor to obtain one or more respective first interim sequences of respective physical layer priorities and repetition factors comprises: concatenating the first interim sequences of each repetition factor of the respective physical layer priorities to obtain one or more second interim sequences; or,
multiplexing multiple pieces of UCI having same respective physical layer priorities and associated with PUCCH of a same respective repetition factor to obtain one or more respective first interim sequences of respective physical layer priorities and repetition factors comprises modulating and encoding, respectively, the one or more respective first interim sequences of respective physical layer priorities and repetition factors; or,
multiplexing multiple pieces of UCI having same respective physical layer priorities and associated with PUCCH of a same respective repetition factor to obtain one or more respective first interim sequences of respective physical layer priorities and repetition factors comprises: multiplexing, respectively, multiple pieces of UCI having same respective physical layer priorities to obtain respective first interim sequences of respective physical layer priorities; and modulating and encoding, respectively, respective first interim sequences of respective physical layer priorities to obtain resulted data of the resulted PUCCH; or,
multiplexing multiple pieces of UCI of the plurality of PUCCHs to obtain a resulted PUCCH further comprises: modulating and encoding, respectively, a third group of UCI associated with a rest of one or more PUCCHs other than the first group of UCI or the second group of UCI in the same slot to obtain third resulted data to be carried by the resulted PUCCH, wherein the rest of the PUCCH have different start slots or different repetitions factor with each other; or,
multiplexing multiple pieces of UCI of the plurality of PUCCHs to obtain a resulted PUCCH further comprises: concatenating a third group of UCI associated with a rest of PUCCHs other than the first group of UCI or the second group of UCI in the same slot to obtain a third interim sequence, wherein the rest of the PUCCHs have different start slots or different repetitions factor with each other; and modulating and encoding the third interim sequence to obtain third resulted data carried by the resulted PUCCH; or,
the method further comprises disregarding a rest of UCI associated with a rest of PUCCH other than the first group of UCI or the second group of UCI.

46. (canceled)

47. (canceled)

48. (canceled)

49. (canceled)

50. (canceled)

51. (canceled)

52. (canceled)

53. (canceled)

54. The method of claim 45, wherein
each piece of the UCI includes a same type of the carried information; or,
each piece of the UCI carried includes different types of the carried information.

55. (canceled)

56. The method of claim 54, wherein multiplexing multiple pieces of UCI to obtain a resulted PUCCH comprises:
multiplexing multiple pieces of UCI of respective types to obtain multiple pieces of interim UCI; and
multiplexing the multiple pieces of interim UCI to obtain resulted data to be carried by the resulted PUCCH.

57. (canceled)

58. (canceled)

59. The method of claim 45, wherein multiplexing multiple pieces of UCI having same respective physical layer priorities and associated with PUCCH of a same respective repetition factor to obtain one or more respective first interim sequences of respective physical layer priorities and repetition factors further comprises at least one of:
modulating and encoding, respectively, at least two of the second interim sequences respectively to obtain resulted data of the resulted PUCCH;
modulating and encoding, respectively, the first interim sequence and the second interim sequence to obtain resulted data of the resulted PUCCH; or
modulating and encoding, respectively, at least two of first interim sequences to obtain resulted data of the resulted PUCCH.

60. (canceled)

61. (canceled)

62. (canceled)

63. (canceled)

64. (canceled)

65. (canceled)

66. (canceled)

67. A wireless communication apparatus, comprising a memory storing one or more programs and one or more processors electrically coupled to the memory and configured to execute the one or more programs to perform the methods of claim 1.

68. A non-transitory computer-readable storage medium, storing one or more programs, the one or more program being configured to, when performed by a processor, cause to perform the method of claim 1.

69. A wireless communication apparatus, comprising a memory storing one or more programs and one or more processors electrically coupled to the memory and configured to execute the one or more programs to perform the method of claim 34.

70. A non-transitory computer-readable storage medium, storing one or more programs, the one or more program being configured to, when performed by a processor, cause to perform the method of claim 34.
